(19) United States
(12) Patent Application Publication
(10) Pub. No.: US 2025/0061324 A1
(43) Pub. Date: Feb. 20, 2025

(54) METHODS FOR THE EFFICIENT MANAGEMENT OF ARTIFICIAL INTELLIGENCE TRAINING WITHIN VIRTUAL ENVIRONMENTS

(71) Applicant: SPACEBRAINZ PRIVATE LIMITED, Singapore (SG)

(72) Inventors: Frederick Gertz, Prosperity, SC (US); Warrick Buchanan, Taipei (TW)

(73) Assignee: SPACEBRAINZ PRIVATE LIMITED, Singapore (SG)

(21) Appl. No.: 18/420,710

(22) Filed: Jan. 23, 2024

Related U.S. Application Data
(60) Provisional application No. 63/481,024, filed on Jan. 23, 2023.

(51) Int. Cl. G06N 3/08

(52) U.S. Cl. CPC G06N 3/08

(57) ABSTRACT

Systems and methods capable of determining appropriate prioritization of Artificial Intelligence training in a virtual environment and in a multi-agent system. A generation system may provide a heatmap to an avatar during gameplay, using the generation system, identifying an area of movement of the avatar within a game. The generation system may perform an analysis of the positioning of the heatmap using machine learning on the heatmap to identify a movement pattern of the avatar based. The generation system may, in response to inferring the areas of movement within the game, divide the areas based on movement, wherein the areas of the heatmap having lower values of movement have a lower priority area and the areas of the heatmap having the greater values of movement have a higher priority area. The generation system allows for the generation of soft/rigid body elements from evolution and expansion of singular elements.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of gaming and Artificial Intelligence (AI), and more specifically to systems and methods for determining appropriate prioritization of AI training in a virtual environment and training in a multi-agent system.

### 2) Description of Related Art

Many modern video games are designed with an eye towards mechanics as purely a ‘gameplay’ mechanic, meaning a mechanism that creates value for the entertainment of the player, and/or for accomplishing tasks within the virtual game environment. With the advent of creator driven platforms, it is possible to create mechanics that both encourage gameplay as well as encourage the creation of objects and/or environments within the game. Many of these games allow for faster creation by incorporating AI in their games to serve a variety of purposes. As a result, certain game mechanics may need to be designed that allow for the encouragement of human problem-solving as well as the development of AI entities within the virtual platform. Thus, there is a need for a method and mechanism that allows for a platform to incorporate AI training into gameplay mechanics. The mechanics balance a variety of different aspects in their design, including performance of the training result for the AI, the experience of the gameplay for the player, and finally the computational efficiency of the training.

It is within the scope of this description to use the terms ‘game’, ‘virtual environment’, and/or ‘artificial intelligence’ somewhat interchangeably. The future of gameplay is envisioned to have a higher degree of cohesion between these elements. In an example, the current progress in procedural game design and storytelling has shown a great deal of progress within these fields. As a result, many games of the future will be environments in which the environment, gameplay, agents and items within the game is constantly evolving based on the player's actions. As such, when referencing these types of games, items in the game for example, a rock, would be positioned in a location as needed by the game environment. The decision to place the rock would be made by some sort of AI that would decide that its positioning was necessary based on its simulation and the actions of the player. This procedural generation would include non-playable character elements, environmental elements such as scenery and objects, as well as storytelling. It is within the scope of this invention for the term ‘procedural generation’ to imply specific algorithms developed for generating desired content, including Machine Learning, Deep Learning, Genetic, and Artificial Intelligence based algorithms. As a result, the current usage of the term procedural generation lacks more general results that can be produced from modern deep learning or similar artificial intelligence based methods. Similarly, the term procedural generation includes simulation based results, meaning that aspects of the virtual environment are simulated, such as the physics or the geography of an area. The ‘simulation-first’ environment is a portion of the gaming experience produced by evolving systems in discrete time steps and plays a part of the technology being described herein. The game may choose to evolve a story and thus adapt the environment to better reflect the story elements that it is generating. Similarly, the term ‘training’ and ‘generation’ may be used interchangeably.

AI-generated heat maps visually represent data and generate insights that enable users to both understand “what is” and predict “what could be.” In an example, a person interested in information regarding a website can use AI-generated website heat maps to see what users are paying attention to on the website and also predict where they are likely to pay attention to in the future on the website.

Since the days of static, pre-made worlds and levels, gaming has advanced significantly. The introduction of procedural generation has transformed the sector by enabling game designers to construct expansive, varied, and dynamic gaming environments. This method, referred to as “system generation,” enables games to provide distinctive experiences each time a player begins interacting with the virtual environment such as pressing a “start” button.

Instead of depending on manually constructed parts, system generation, also known as procedural content creation, uses algorithms and data to build game content on the fly. It includes a variety of game-related elements, such as:

Level Design: Procedural generation algorithms may build settings, mazes, and topography in place of manually creating each level, guaranteeing that no two playthroughs are same.

Character Creation: Games can create characters, enemies, or non-player characters (NPCs) with distinctive skills, features, and personalities.

Placement of objects: To keep the player's experience new, the distribution of resources, weapons, and objects can be procedurally generated.

Storytelling: Some games use system generation to produce missions or branching narratives that change based on player decisions.

World Construction: Some games employ procedural generation to build vast, open worlds populated by a variety of biomes, buildings, and creatures.

The capacity to provide practically limitless replayability is one of system generation's benefits. Every time a player plays the game, they may get a unique experience, keeping it fresh. The experience may be never ending, since there are endless numbers of objects created in the game,

Efficiency: Procedural generation may drastically cut the amount of time and money needed to produce a game. With less manual design labor, it enables game creators to generate vast game environments.

Adaptability: Some games employ system generation to adjust to the skill level of the player, maintaining the game's difficulty and allure.

Unpredictability: The introduction of unpredictability through system creation might make it difficult for players to rely on remembered methods. Each playback includes a surprise element as a result. One benefit of the system or game is the ability to create highly targeted content specifically focused on the desires and preferences of the player/players. The feedback of the system may be provided through the use of AI agents which offers the targeted content.

Game makers and gamers alike now have new opportunities thanks to system creation. Infinite innovation is possible, progress is expedient, and there is enough unpredictability to keep players interested. We may anticipate that system creation will become ever more complex as technology develops, obfuscating the distinction between scripted and dynamically produced game material. System generation has transformed the game industry and is expected to continue reshaping interactive entertainment in the future, whether it's exploring extraterrestrial worlds, traversing perilous dungeons, or creating your own virtual environment.

Modern AI systems may incorporate a class of algorithm referred to as Generative AI, where the algorithm does not simply optimize or perform pattern recognition within a defined system, but actively generates new output. In this type of algorithm typically a mathematical space is defined, usually referred to as a latent space, and the algorithm generates output from this. As such the algorithm learns a latent space by iteratively generating new content, as such the training and learning aspects of the process are more holistically combined. It would be more desirable for a neural network to be configured to receive user input and then adapt it for the output to generate new content to facilitate a more fluid process, than in the traditional training and inference paradigm used in modern AI applications. Further, the terms ‘training’ and ‘generation’ may be used to better reflect this. As such, the technical problem that is being solved is that many of these systems will need to use multiple AI agents to perform these tasks, and choosing the best methods and/or determining how a large system would handle that training is currently not known and there remains a need in the art for a solution to at least one of the aforementioned problems.

### BRIEF SUMMARY OF THE INVENTION

Thus, there is a need for systems and methods capable of determining appropriate prioritization of AI training in a virtual environment and in a multi-agent system which addresses at least some of the above discussed issues, as well as techniques that can facilitate ground up generation of new content within such an ecosystem.

Some embodiments of general training methods are proposed.
1) Multi-agent training, particularly focused on multi-player gaming environments. One player is able to ‘summon’ another player to assist them in the training of AI agents. In this method, the system not only allows for the additional input, but it also tracks the amount of training effort that should be ascribed to the new, ‘summoned’ player. This can scale to the nth degree number of assisting players. It should be noted that depending on the environment, the introduction of an additional agent, in this case described as the ‘summoned’ player, does not necessarily require an actual invitation, but could theoretically be introduced in a variety of means. This includes the player choosing to introduce themselves to the environment or via overall ‘matchmaking’ selection process as offered as another service that determines additional agents, or specific additional agents are needed for players. The idea of players being able to ‘snipe’ or introduce themselves and perform tasks related to training or playing of specific environments is a beneficial concept in this idea as it both introduces additional gameplay mechanics as well as additional training elements.
2) A variety of methods are described that allow for the prioritization of training and determining which AI training or generation should take place locally and what might be either deprioritized, or scaled to more efficient models, or even sent to cloud computing systems (or similar systems, such as distributed computing or blockchain computing systems) for background processing.

The techniques described herein relate to a computer readable medium including instructions which, when executed by a processor, cause the computer to carry out the steps of: providing a heatmap to an avatar during gameplay, using a generation system, identifying an area of movement of the avatar within a game; performing, by the generation system, an analysis of a position of the heatmap using machine learning on the heatmap to identify a movement pattern of the avatar based; and in response to inferring the areas of movement within the game, the generation system dividing the areas based on movement, wherein, the areas of the heatmap having a lower value of movement as being a lower priority area and the areas of the heatmap having a greater value of movement as being a higher priority area.

In one embodiment, the system relates to a computer readable medium, further including performing, by the generation system, a simulation on the higher priority area to train at least one artificial intelligence entity.

In another embodiment, the system relates to a computer readable medium, further including in response to detecting a lower priority area, by the generation system, downgrading at least one system element.

In another embodiment, the systems described herein relate to a computer readable medium including instructions which, when executed by a processor, cause the computer to carry out the steps of: providing a heatmap to an avatar during gameplay, using a generation system, identifying a radius of interaction between the avatar and at least a portion of a virtual environment within a game; performing, by the generation system, an analysis of the heatmap using machine learning on the heatmap to identify an interaction pattern of the avatar and the at least a portion of the virtual environment within the game; and in response to identifying the interaction pattern, the generation system, dividing the interaction pattern based on heat transfer, wherein, an area of the heatmap having a lower value of heat transfer being a lower priority area and an area of the heatmap having a greater value of heat transfer being a higher priority area.

In some aspects, the systems relate to a computer readable medium, further including performing, by the generation system, a simulation on the higher priority area to train at least one artificial intelligence entity.

In some aspects, the systems relate to a computer readable medium, further including in response to detecting a lower priority area, by the generation system, downgrading at least one system element.

In some aspects, the techniques described herein relate to a computer-implemented method for procedural generation including: providing user input data from a gameplay, using a generation system, to establish a baseline, said user input data is a mechanism from the gameplay; performing a simulation, using machine learning, on the baseline to identify the mechanism and to generate loss function optimization based on differences between the simulation and baseline; updating a network parameter, using feed-forward propagation or backpropagation, to reinforce the network; and in response to updating the network parameter, generating, using the generation system, new content for the gameplay.

In some aspects, the techniques described herein relate to a computer-implemented method, further including optimizing the loss function, by the generation system, to generate the network parameter with decentralized ledger technology (blockchain) location. Not only is the blockchain used in the generation but the blockchain (i.e. decentralized ledger technology) can be used to store the history and different versions and parameters of the loss function.

In some aspects, the techniques described herein relate to a computer-implemented method, further including presenting, by the generation system, a listing of items of the loss function on a display and selecting, using the generation system, an item from the listing to prioritize a virtual environment.

In some aspects, the techniques described herein relate to a computer-implemented method, further including presenting, by the generation system, a listing of items of the loss function on a display and selecting, using the generation system, an item from the listing to prioritize a virtual environment. A loss function measures how well the model performs on training data. By minimizing the loss, the model gets updated to improve its predictions.

In an embodiment, a method configured to be used to solve a variety of problems related to improving aspects of procedurally generated content for games is provided. As a result, this method allows for the more efficient capture of user input from multiple players.

In an embodiment, a method for a system is configured to prioritize selected content to generate so efficient pipelining can be performed by the overall generation system with as little disruption to game playability as possible. Pipelining in gaming refers to the graphics pipeline, which is the process or “pipeline” that game engines use to render 2D and 3D graphics whereby the graphics pipeline takes 3D models and converts them into 2D images on the screen using transformation of geometry, lighting, shading, rasterization and the like. Pipelining takes advantage of parallel graphics hardware and increases overall throughput and allows higher frame rates compared to executing each frame in sequence. In yet another embodiment, a method is configured for the generation of soft and/or rigid bodies and their accompanying mechanics for virtual environments.

In procedurally generated content, i.e. games that are produced through algorithms or AI, content is trained and/or generated by taking input data from the user and then transforming the data into content for the game. This training, or generation, of content is a beneficial aspect, but is computationally intensive. Both the collection of the input data can be arduous as well as the generation of the content. In an embodiment, a method is configured to improve the collection of training data.

In another embodiment, the multiplayer gaming method allows additional players to assist in the training.

In another embodiment, a method facilitates the system to prioritize the content to generate and the AI to train so that the system can most efficiently process data streams.

The invention can be used in gaming systems, especially those with large amounts of procedural content to allow for better collection of data in a multi-agent system, as well as the processing of data for those systems.

Currently, content generation through procedural methods is either highly limited to the computational ability of the system a player is on and/or requires lengthy, non-playable periods of generation prior to the player engaging with the content. The methods here proposed allow for more efficient processing of that information in both the collection side, by allowing multiple agents to participate in providing inputs for the system, as well in the output side, by determining what priority certain content should get in the generation.

An embodiment of a technical solution to current systems not designed for high efficiency to the aforementioned technical problems includes a method for AI-driven procedural content generation, similar to culling used in 3D graphics. In modern games for example, even though the entire 3D representation of an environment may exist within the systems memory, the game chooses to not ‘draw’ or graphically represent the entire environment, and usually prioritizes the drawing of elements that are the player is actively looking at. Similarly, elements further away may be drawn at lower resolutions. This drastically increases the efficiency that 3D game environments can be rendered.

### Training Mechanics

In regard to multiplayer mechanics, a method for training an AI entity and/or virtual environment with the intent of allowing a group of players to be involved in the training of the entity is described. One of the problems faced with AI driven generation systems is their need for input data. In many systems, especially systems in which there is a single agent and/or player in this example, the system will eventually collapse in a local minima. This can be solved by adding multiple agents and/or allowing multiple players to participate in the training. A method for allowing such training, and doing so in a game mechanic that both enhances playability as well as could be applied across multiple gaming paradigms is described. It is within the scope of this invention for a variety of different machine learning algorithms and/or protocols to be used including, but not limited to, a Decision Tree, a Neural Network, a Random Forest, a Boosted Tree, a Support Vector Machine, a Convolutional Neural Network, a Generative Adversarial Network, a Logistic and/or Linear Regression, Transformers and Genetic Algorithms.

In an example, a Recurrent Neural Network (RNN) is learning to fight a specific entity. It is using the players actions to Reinforce and update the network parameters using standard propagation techniques such as feed forward or backpropagation. The RNN tries to simulate an attack mechanism from the gameplay, and then compares how its attempt matches the attempt of the players. The loss function is based on a mathematical model that attempts to describe the difference between the RNN's chosen actions and the players, and a reward function is used based on the damage done to the entity in the game. After some time, the player may find many effective ways to damage the entity, but perhaps has not identified ideal game mechanics to defeat or effectively injure the enemy. This proposes a variety of issues, including the player may be teaching the RNN to perform ineffectively, or at least non-ideally for certain situations. As such, the player, wishing to add additional variables to the RNN's parameters or training environment, could then invite another player, to fight either using their ‘avatar’ or having the RNN monitor the other players attempts. This player would enter the arena and the new loss function optimization would be performed based on their actions. The steps to this optimization could then be stored either in a central location that tracks the amount of parameter changes being undergone by the neural network as a function of interactions with different entities, and/or on a system incorporating a decentralized ledger technology such as a blockchain. The RNN would then be trained more effectively with the input of the other player and their contributions are noted for the steps of the training. It should be noted that the act of this type of training constitutes a type of simulation where the player can take part. Problems such as these can be mapped and then delivered to a variety of individuals for them to solve, representing a method of asynchronous training that can take part across multiple virtual environments concurrently.

Selection of Models for Simulation with a Game Environment

One of the benefits for the gameplay is balancing interactions between the computer system, human interactions, and AI. As such in certain environments the user may, for a variety of reasons, perhaps performance and perhaps aesthetic decide that they are willing to sacrifice model accuracy to free up available system resources. In cases like this based on the players preferences the system may automatically substitute a model including, but not limited to, AI, that is an appropriate approximation of the other model with the hopes of creating more efficient outputs, even if some accuracy suffers. An example might be that a game requires two large armies to fight. The player would like to simulate the armies fighting, but the most important element to them is that the armies fighting have a size as large as possible. They have trained neural network models that can be used in such simulations, but these models require a considerable amount of computing power to be used effectively. As such they are best used on this user's system when the army size is very small. As such the computer, to allow for larger battle sizes, would select a different model, such as the Lanchester Attrition Model, which is considerably lighter on the system for the simulation. As a result, simulation results are delivered faster and at a larger scale. This method could be used for a variety of different areas. In the statistical replacement of AI models, GAN results usually can mirror complex distributions and then use that data to create outputs that appear statistically likely in a high dimensional representation of the distribution. For a system looking to lighten the computational load, simpler statistical distribution models, such as, in a lower dimension may be developed and used.

The selection of the models has two different systems. It should be noted that the user would have several opportunities to configure systems that meet their specific needs and as such are not necessarily limited to the hardware solely available on their system but may choose based on the desired result to enhance their system performance through the incorporation of select distributed computational or cloud computing elements.

### Manual Selection

One method for the selection of the appropriate balance between playability and computation is to allow the user to decide through a manual selection process. Items that would be incorporated into the loss function are presented to the user, and perhaps are even presented as some graphical user elements such as dials or sliders that assist in the selection of the appropriate values. Users attempting to prioritize the game-like elements of certain situations or virtual environments can set the priority using those values as well as setting the priority of the computations through such an interface. These values would then be translated into a loss function and the system would use the appropriate load-balancing method to achieve that desired result in the virtual environment.

### Selection Based on Available Resources

Players may choose to use a method related solely to traditional load-balancing efforts for distributed systems and incorporate the use of load balancing mechanism that allows for the utilization of different available computational elements at different rates. A loss function would be described that attempts to maximize the system performance and number of elements, as well as the AI effectiveness within the environment. Balancing the elements of the AI effectiveness through traditional means such as, an F1-Score, a learning rate such as by monitoring change in effectiveness and/or time to implement a traditional optimizer such as, a standard Adam, with an appropriate learning rate is achieved. The F1 score is also known as F-measure, or balanced F-score and is an error metric which measures model performance ranging from 0 to 1 where 1 is the best possible score and use of the F1 score provides a robust metric for model performance. Additional metrics for measuring model performance are R-squared, mean Squared Error, Root Mean Squared Error, Gini Coefficient, log-loss or Area under the ROC Curve could all be used, as well as many other algorithms, although other metrics for measuring the model performance may be used.

The F1 score is a popular metric to use for classification models as it provides accurate results for both balanced and imbalanced datasets, and takes into account both the precision and recall ability of the model. It is within the scope of this invention for the system to incorporate a standard loss function methodology, through the use of a minmax function shown in the example of FIG. 9.

In such a system, the element being optimized: O, can be described in a variety of ways. For example, the user would use a O of a form where user performance is described by the number of frame rates being delivered to the user and system performance is described by the output of the artificial intelligence F1-score. The loss function would be the difference between these two elements with appropriate weighting/fitting parameters applied. Loss functions may also be applied to ‘softer’ mathematical representations such as popularity of an AI element in a marketplace, positive player interactions recorded within the environment, or even number of total interactions/user engagement with the entity.

### Heatmap and Radius of Interaction

In an aspect, a method for use of player interactions with the environment to govern the decision on what to prioritize in processing is described. In this method, the player goes through normal gameplay and the player interacts with various elements of their environment, which can be decided in a variety of ways. The classic approach would be to apply a heatmap to the players movements throughout the game and then use that to both infer and predict areas of higher interest within the game. Once an area of priority has been identified using the players movement heat map, the areas with the highest priority are given the largest segment of system resources to both simulate and train artificial intelligence entities. Other areas of lower priority can then have a variety of different events occur for the lower priority items. First, the system may decide to take less important elements and downgrade their quality, using simpler models for their description. It should be noted that the heatmap method can also be in itself a simplification, where the heatmap acts as a look-up table, telling the system which areas of important data should be prioritized in training and generation.

For example, a heatmap based on including, but not limited to, Machine Learning, may determine priority based on either proximity or predicted proximity. Capturing those aspects, in addition to also capturing are the ‘graph-like’ effects in which features of a virtual environment are connected with contacts. Contacts may include, but are not limited to, a graph database having edges and/or vertices. In particular, the capturing of the 2nd order effect, wherein the heatmap represents the number of connections that something has in relation to an event and/or at least one object. For example, when there are two players in an environment, each player needs to acquire some sort of items of magical origin. In this virtual environment, all magic comes from a river and neither player knows where the location of a river is. When the players are traveling within the virtual environment around the map, they perform tasks to acquire the objects of magical origin, but they never actually visit the origin of the river. The virtual characters may have interactions such as fighting and/or acquiring objects, however, the place of origin, has never been visited because it is generating objects of importance through a plurality of 2nd and 3rd order interactions and needs to be a place that has a ‘higher’ priority in the game/simulation environment. Thus, using a graph database, a plurality of interactions constantly create connections back to the origin and thus, help increase its priority so that it gets more simulation resources.

In an example, using the system, a player's avatar enters into an environment where a large army is fighting. As they are looking at the army, the system is using a large neural network that is controlling each element of both armies and showing in great detail the armies battling between themselves. The player then chooses to walk to another area where the fighting is not occurring. Because the result of the fight is important to the gameplay when the player returns, a result of the battle would be desirable to generate. Since the player is no longer actively looking at the battle the system detects this and switches to a simpler neural network model that instead of simulating each element of the fight, the system technically receives and analyzes input parameters about the two armies and then predicts the winner. When the player eventually returns to that area, the scene is rendered with the appropriate winner based on this result. As such the computational resources are preserved for other tasks, and the system automatically selects the appropriate resources. In this embodiment, the presence of the player was used to decide the prioritization of resources. Below are other embodiments.

One embodiment of this selection method is the use of what we refer to as Diffusion based importance and is somewhat similar to methods used by optimization functions such as, an Ant Colony Optimization (ACO). In this method the importance of objects is determined also by a heat like map, but the importance is not purely based on position, but also on interaction. When a player interacts with an object or element with the virtual environment, the object or element is imbued with an element of ‘heat’ much like in a thermodynamic system. As such the element is ‘hotter’ for having interacted with the player. This heat dissipates at some appropriate rate, but the as that element is interacted with it can also spread some of this ‘heat’ to the objects it interacts with. This type of result is important especially when concerning multi-agent systems, where the importance of system prioritization is determined from a variety of agents. In such a system, a single interaction with one agent may not cause enough heat to be transferred to the entity, but many interactions, possible with many agents would cause the item to heat up to a point where it moves higher up in system computational priorities. As such, elements that interact with this object would also take some amount of heat, and thus 2nd order interaction or prioritization could be determined by the system in a computationally efficient manner.

Finally, a graph-based method could also be envisioned, whereby each element in the game is represented with a large mathematical graph. Interactions between elements is recorded with vertices within the graph. Elements in the game that have more edges, or vertices pointing in their direction would thus be given higher prioritization within the system. Priority could be established simply by walking the graph or by having elements self-report their number of vertices. This system would also facilitate simple second order interactions, by way of walking the graph relationships, and ‘relationships of relationships’ would be established. Simplification of User Generated Content

The graph-based method could also be applied not just to the simulation of events within a game, but across almost any generation of content. The method is expanded into the realm of user-generated content. By capturing the input from users, the graph-based method can direct the generation of general content creation, and using the methodologies described in this document, the generation system can assign importance of items for user-generated content. Once a user generates certain content that is imported into the system, the system may apply approximations to create simpler models so that the model can be run more efficiently. For example, a user may play a game such as classic civilization generations games. In such a game, the user generates certain content, like laying out a city that has an advanced infrastructure including roads and waterways. Because the area is quite large, the game may choose to simulate certain parts of the content, such as the number of car accidents using simpler statistical models rather than specific dynamical models. In this way, the user may generate a variety of content and using the described simplification/prioritization methods, the system would automatically determine the appropriate models to be applied for continuation of in game content production.

Content generation techniques could also use large neural networks trained for Natural Language Processing (NLP). These systems, known colloquially as Large Language Models (LLM's) can be used via prompt engineering to create and describe the content that is being generated, and can even be used as a seed system for generating additional content as well as interactions with the game environment. From creating written descriptions of the environment to the creation of scripts or dialog in the game and even creating written histories or language with the environment, LLM's can be leveraged in this simulation system both for creating initial content as well as by taking in simulation results and enhancing them with the aforementioned content examples. The simulation system can act as a powerful content generation system to leverage LLM's for enhancement as well as produce content that can be fed back into an LLM for training, updating internal parameters as a type of synthetic Retrieval Augmented Generation system that provides in-game content in the form of prompts as additional content for the LLM to leverage.

### Evolution of Rigid/Soft Body Structure

In many gaming environments, there will be a need to go beyond the simple creation of simple objects. Going back to the above rock example, many content generation platforms will require the evolution of complex structures. If, for example, the production required a creature to be inserted into the game, there would be an expectation that the creature would be able to perform complex mechanics, including around the generation of rigid and soft body physics. In modern development a designer would artistically draw, for example, a human. This human would not be able to move or perform any mechanical tasks. It would have a skeleton applied fitting different points of the model to virtual mechanical joints. Next, the person would be movable within a virtual environment, and these joints would be manipulated to allow for animations in which the different pieces of the model would move in a choreographed fashion to perform tasks. This can be thought of as a top-down approach to the problem. We propose that through the use of AI this can be evolved from a bottom-up approach.

By taking a single element, in this example we use a small spherical element, we would evolve structure of complexity both in imagery as well as in mechanical aptitude. Again, using a neural network approach is for the purpose of explanations, and a variety of different machine learning paradigms could be leveraged to accomplish this framework as described herein. The method of this evolution places a single element within the environment and attempts to evolve the element into a complex structure. To do this, a single element will evolve into a structure to perform a task, such as including, but not limited to, jumping. By taking a recurrent neural network and giving it a reward function based on the height achieved by the object it is evolving. The single element is placed in a virtual environment having physics similar to real-world physics, especially with regards to gravity. The recurrent neural network takes this single sphere which has an associated physics as well. Much like modeling clay it would have a certain amount of rigidity, moldability and elasticity as described in the accompanying physics model for the single element. The RNN would then attempt to mold, shape, or manipulate the item to try and achieve an improvement in its reward function. This could be accomplished using several different methods, including, but not limited to, genetic algorithms and/or gradient descent learning. After sufficiently exhausting the manipulation of a single element the RNN would then add an additional element and then repeat the process of manipulating both elements until the maximum reward function is achieved.

In this way one can imagine, much like cells evolving in an environment, that eventually the RNN would evolve structures similar to bones, and similarly softer force applying materials, much like muscles that would allow for the articulation of these rigid structures and the structure could evolve a ‘leg’-like structure that allows for hopping. This has multiple advantages. First, the evolution of the structure does not necessarily require human input beyond the creation of a sufficient reward function. While the process may be computationally intensive it is light on necessary human resources. Second, the entity that is evolved does not require any additional steps to create motion, the structure of the entity as well as its articulation are evolved together. No artist or 3D renderer is required to determine appropriate mechanics of the entity, this is accomplished through the creation process. Finally, the result might be unexpected, which could provide unique and entertaining outputs. In the above description the example shows the system may evolve ‘legs’ because that is an obvious structure to many people to accomplish the act of jumping, but the RNN in this case may evolve completely alien structures that accomplish the task.

Physics simulations using particle or sphere representations are known to be computationally efficient. Spheres as a base modeling primitive in 3D modeling software such as ZBrush with its ZSphere tool, are known to be efficient for quickly and roughly describing articulations of 3D models and their volume. In an embodiment, a target articulation of spheres defined by a user is used as a target for a machine learning mechanism such as a recurrent neural network which has an infinite impulse response. The network learns to grow from a root sphere the articulation made of spheres to match the user defined target articulation. In an embodiment, the method runs a physical simulation of the growth of the articulation towards the target, which uniquely pushes against and deforms a mesh surrounding the articulation. The mesh is either hexahedral or tetrahedral in nature, and defined by vertices connected by edges. The mesh simulation uses Finite Element Method (FEM) simulation or similar processes such as Position Based Dynamics (PBD) or least squares shape matching to produce the result of a skin that is deformed by the underlying articulation of spheres. Certain spheres may be assigned by the growth mechanism as attachment points that have a sticky attraction to nearby vertices of the skin mesh. In this way the skin begins to model folds and wrinkles as the articulation grows. As parts of the skin mesh edges stretch past a specified threshold of extension that is related to the time step of the physics simulation, the mesh may subdivide using various methods to release its surface tension and allow limbs to extend with adequate skin covering. Measurements of stretch between the skin mesh vertices may also affect directly or indirectly determining properties of the skin surface such as albedo color or material. Simulations similar to Gray-Scott reaction diffusion may source their parameters from such information, and be used to determine the resultant skin surface properties at each skin mesh vertex. These features may also drive the growth of additional physical features such as physically simulated hair sprouting from each vertex as a mass particle physics simulation. The underlying sphere articulation is then used as a skeleton for animation determined via physical simulation. The skeleton can be driven by a machine learning algorithm that has evolved to understand and control the articulation within an artificial life simulation. The growth of the virtual creature can take place embedded within a fluid simulation. Where particles of different types can be added to the fluid simulation, and can affect the surface of the skin mesh when contacted, having secondary effects that determine the properties of the skin mesh at its surface vertices, that then may be propagated internally within the skin mesh. Each edge in the skin mesh may have a custom elasticity value assigned, which can be affected by the propagation of features throughout the skin mesh from the contact of particles within the containing fluid simulation, and also from points of contact from the internal spherical articulation.

The physics actuation of the articulation made of multiple spheres can be done by rigid body physics simulation, and also in combination with a muscle system similar to the paper ‘VIPER: Volume Invariant Position-based Elastic Rods’. The spherical particles within the muscle rods can be used to drive further interactions with the properties of the skin mesh vertices during growth. And the machine learning algorithm used to drive such actuations may trigger movements that happen throughout the growth phase and thus indirectly influence how the properties of the skin mesh progress. As the articulation grows its structure consisting of branches of connected spheres of different scales, it can also define a routing of a central nervous system between the connected spheres that is used by the machine learning algorithm that controls actuation to send control signals along the sphere connections to signal various motor joints between spheres as well as connected muscle rods. Thus, the morphology and intelligence become interrelated as in nature.

Further, uniquely the machine learning mechanism used for the growth of the articulation may be trained across many different user-defined articulations to establish a learned latent space that can be associated with specific keyword associations. Allowing the system to grow unique variations of structures given such keywords. Furthermore, this training can be enhanced by the use of the graphical rendering of the resultant structures from various viewpoints, which can then be compared to image databases of various objects such as creatures that match the specific keywords that are used in training.

As a result of these systems and methods, a drastic increase in the amount of content may be produced and better playability generated. The multi-agent method for capturing training data is provided by way of game mechanics, making it an ideal fit for game environments.

One aspect of the present invention is directed to a system for growing an articulated structure. The system includes a plurality of spheres, each sphere disposed adjacent to at least one other sphere of the plurality of spheres to form the articulated structure. The system includes an outer skin to which the articulated structure is attached, the outer skin simulated as a soft body. The outer skin has a geometric shape which may be a tetrahedron or a hexahedron. The system includes a computational network integrated within connections between adjacent spheres for distributing communication signals. The system includes a multiphase flow fluid simulation system in which the articulated structure and outer skin are embedded, the multiphase flow fluid simulation system including suspended particles. The outer skin may be configured to subdivide in response to tension caused by growth of the articulated structure whereby generation of sampleable parameters are influenced by gradient changes on the surface of the outer skin. The fluid simulation system is selected from the group consisting of Material Point Method (MPM), Smoothed Particle Hydrodynamics (SPH), Lattice Boltzmann Method, and Fluid-Implicit Particle (FLIP) method, and the interactions within this system contribute to the development of the skin surface parameters.

Another aspect of the present invention is directed to a computer readable medium including instructions which, when executed by a processor, cause the computer to carry out the steps of using a neural network to provide a heatmap to an avatar during gameplay wherein areas of interaction of the avatar are analyzed and applied to the heatmap to identify an interaction pattern of the avatar. The areas of the heatmap that have a lower value of interaction are assigned a lower priority area and the areas of the heatmap having a greater value of are assigned a higher priority. The steps include using the heatmap to allocate a greater portion of processor resources to the areas of the heatmap having a greater priority. The neural network may be a recurrent neural network. The neural network may be a large language model neural network for creating initial content and for enhancing simulation results.

Another aspect of the present invention is directed to a computer readable medium comprising instructions which, when executed by a processor, cause the computer to carry out the steps of initiating training on a neural network in providing a heatmap and updating information in the heatmap of input parameters used to identify priority language parameters. The areas of the heatmap that have a lower value parameter are assigned a lower priority and the areas of the heatmap having a greater value parameter are assigned a higher priority. The steps include using the heatmap to allocate a greater portion of processor resources to the areas of the heatmap having a greater priority, and using the information to determine appropriate type of model sizes and efficiencies to handle tasks according to priority. The neural network may be a recurrent neural network. The neural network may be a transformer model used in a Large Language Model.

Another aspect of the present invention is directed to a computer readable medium comprising instructions which, when executed by a processor, cause the computer to carry out the steps of providing a heatmap to an avatar during gameplay, using a generation system, identifying an area of interaction with other avatars or game environment and the objects within said the game environment. The steps include the generation system performing an analysis of a position of the heatmap using machine learning on the heatmap to identify an interaction pattern of the avatar and in response to the analysis inferring the areas of interaction within the game, the generation system dividing the areas based on interaction, wherein, the areas of the heatmap having a lower value of interaction as being a lower priority area and the areas of the heatmap having a greater value of interaction as being a higher priority area.

Another aspect of the present invention is directed to a computer-implemented method for training a neural network within a gameplay. The method includes providing player input data from the gameplay and the neural network establishing a baseline using the player user input data is a mechanism from the gameplay. The method includes the neural network performing a simulation on the baseline to generate loss function optimization based on differences between the simulation and baseline. The method includes updating a network parameter to reinforce the network and in response to updating the network parameter, generating, using the generation system, new content for the gameplay. Updating the network parameter may use feed-forward propagation, backpropagation or a combination of feed-forward propagation and backpropagation.

Another aspect of the present invention is directed to a computer readable medium including instructions which, when executed by a processor, cause the computer to carry out the steps of using a neural network to generate an object based on learned data wherein the neural network provides an overarching constraint for the system to evolve an object based on the training data received.

Another aspect of the present invention is directed to a method for growing an articulated structure having a plurality of connected spheres. The method includes connecting spheres in the articulated structure wherein each sphere is connected to a at least one other sphere and the articulated structure is attached at points to an outer skin. The outer skin is simulated as a soft body and comprises a geometric mesh shape selected from the group consisting of a tetrahedron and a hexahedron. The connections between the spheres form a network capable of distributing communication signals for computational processes that influence the movement and growth of the articulated structure. The growth of the articulated structure may cause stretching and deformation of the outer skin wherein the outer skin subdivides in areas of high tension and the subdivision of the outer skin results in a cascade of sampleable parameters across the skin surface, the parameters being influenced by gradient changes akin to a reaction-diffusion pattern. The method may include embedding the articulated structure and outer skin within a multiphase flow fluid simulation system, wherein the fluid simulation system is selected from the group consisting of Material Point Method (MPM), Smoothed Particle Hydrodynamics (SPH), Lattice Boltzmann Method, and Fluid-Implicit Particle (FLIP) method. The fluid simulation system may include suspended particles. Interactions between the suspended particles and the outer skin may contribute to the development of the skin surface parameters. The interactions between the suspended particles and the outer skin in the fluid simulation system may enhance the complexity and variability of the parameters on the skin surface.

Another aspect of the present invention is directed to a system for growing an articulated structure. The system includes a plurality of spheres, each sphere disposed adjacent to at least one other sphere of the plurality of spheres to form the articulated structure. The system includes an outer skin to which the articulated structure is attached, the outer skin simulated as a soft body, the outer skin having a geometric shape selected from the group consisting of a tetrahedron and a hexahedron. The system includes a computational network integrated within connections between adjacent spheres for distributing communication signals. The system includes a multiphase flow fluid simulation system in which the articulated structure and outer skin are embedded, the multiphase flow fluid simulation system including suspended particles. The outer skin may be configured to subdivide in response to tension caused by growth of the articulated structure whereby generation of sampleable parameters are influenced by gradient changes on the surface of the outer skin. The fluid simulation system may be selected from the group consisting of Material Point Method (MPM), Smoothed Particle Hydrodynamics (SPH), Lattice Boltzmann Method, and Fluid-Implicit Particle (FLIP) method, and the interactions within this system contribute to the development of the skin surface parameters.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a high level block diagram illustrating the system for procedural generation in a virtual environment;

FIG. 2 is a flow chart illustrating a method for procedural generation in a virtual environment;

FIG. 3 is a flow chart illustrating an alternate method for procedural generation in a virtual environment;

FIG. 4 is a flow chart illustrating an alternate method for procedural generation in a virtual environment;

FIG. 5 is a diagram for AI agents to be trained by the interaction of players;

FIG. 6 is a diagram for AI agents to be trained by the interaction of players and interaction with the agent;

FIG. 7 is an alternate diagram of AI agents to be trained by the interaction of players and interaction with the agent wherein the AI agents are trained directly from player input;

FIG. 8 is a diagram of the system in its simplest form wherein multiple AI agent are trained using the gameplay computer and the computer interaction with a single player; the AI agent may be involved in the interaction wherein the computer system uses input data received from the AI agent;

FIG. 9 shows a standard loss function equation as an example of use of a minmax function; and

FIG. 10 is a diagram illustrating an embodiment of a root sphere being perturbed and grown to allow for articulation and advancement underneath an elastic membrane in the virtual environment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

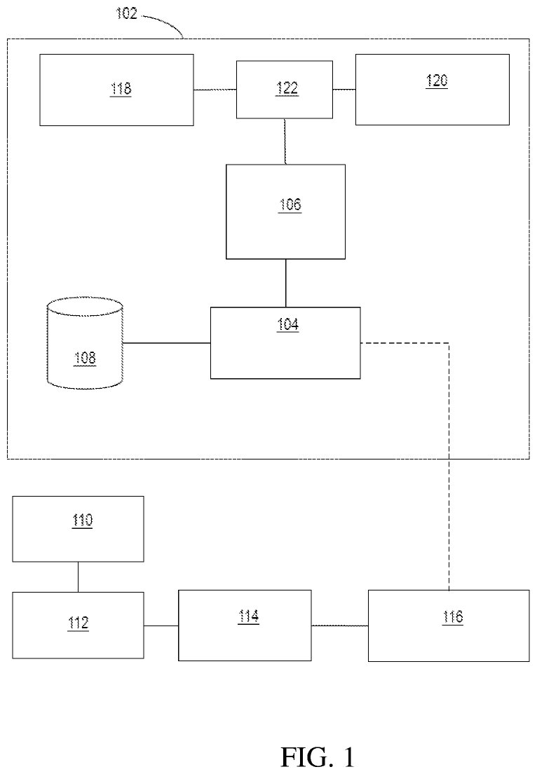

FIG. 1 is a block diagram illustrating system 100 for procedural generation 102 in virtual game environment 104. Machine learning 106 technique such as, a neural network model, may be used for training 122 of virtual game environment 104. In this illustration, a neural network receives user input from at least one agent 118 and/or at least one player 120 and then adapts it to generate new content for virtual game environment 104. Network 108 is in communication with virtual game environment 104. Electronic device 110 may have display 112 with user interface 114. Creator driven platform 116 is in communication with a virtual game environment 104 and/or AI entity.

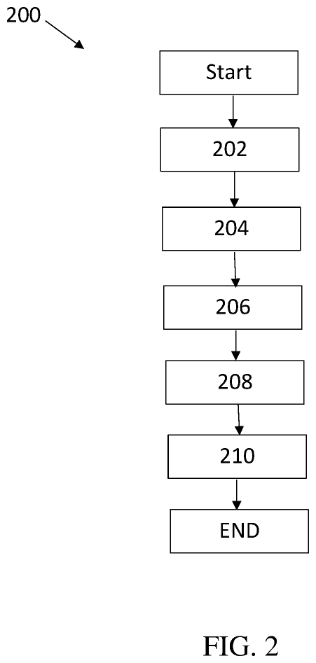

FIG. 2 is a flow chart illustrating method 200 for procedural generation in a virtual environment. At step 202, providing a heatmap to an avatar during gameplay, using a generation system, identifying an area of movement of the avatar within a game. At step 204, providing a heatmap to an avatar during gameplay, using a generation system, identifying an area of movement of the avatar within a game. At step 206, providing a heatmap to an avatar during gameplay, using a generation system, identifying an area of movement of the avatar within a game. In an alternate embodiment, step 208 shows providing a heatmap to an avatar during gameplay, using a generation system, identifying an area of movement of the avatar within a game. In an alternate embodiment, step 210 shows in response to detecting a lower priority area, by the generation system, downgrading at least one system element.

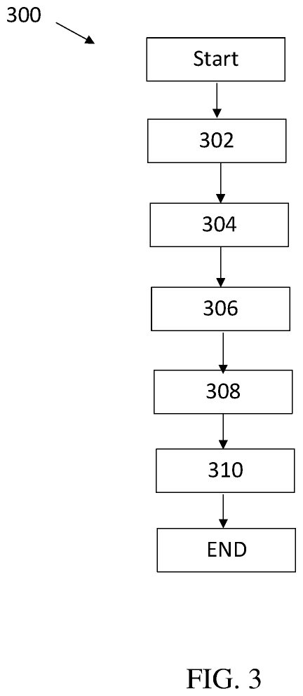

FIG. 3 is a flow chart illustrating alternate method 300 for procedural generation in a virtual environment. At step 302, providing a heatmap to an avatar during gameplay, using a generation system, identifying a radius of interaction between the avatar and at least a portion of a virtual environment within a game. At step 304, performing, by the generation system, an analysis of the heatmap using machine learning on the heatmap to identify an interaction pattern of the avatar and the at least a portion of the virtual environment within the game. At step 306, in response to identifying the interaction pattern, the generation system, dividing the interaction pattern based on heat transfer, wherein, an area of the heatmap having a lower value of heat transfer being a lower priority area and an area of the heatmap having a greater value of heat transfer being a higher priority area. In an alternate embodiment, step 308 shows performing, by the generation system, a simulation on the higher priority area to train at least one artificial intelligence entity. In an alternate embodiment, step 310, in response to detecting a lower priority area, by the generation system, downgrading at least one system element.

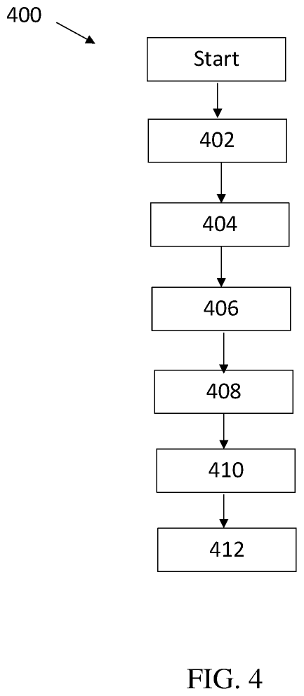

FIG. 4 is a flow chart illustrating alternate method 400 for procedural generation in a virtual environment. At step 402, providing user input data from a gameplay, using a generation system, to establish a baseline, said user input data is a mechanism from the gameplay. At step 404, performing a simulation, using machine learning, on the baseline to identify the mechanism and to generate loss function optimization based on differences between the simulation and baseline. At step 406, updating a network parameter, using standard propagation techniques such as feed-forward propagation or backpropagation, to reinforce the network. At step 408, in response to updating the network parameter, generating, using the generation system, new content for the gameplay. In an alternate embodiment, at step 410, optimizing the loss function, by the generation system, to generate the network parameter with decentralized ledger technology location. In an alternate embodiment, at step 412, presenting, by the generation system, a listing of items of the loss function on a display and selecting, using the generation system, an item from the listing to prioritize a virtual environment. In an alternate embodiment, at step 414, presenting, by the generation system, a listing of items of the loss function on a display and selecting, using the generation system, an item from the listing to prioritize a virtual environment.

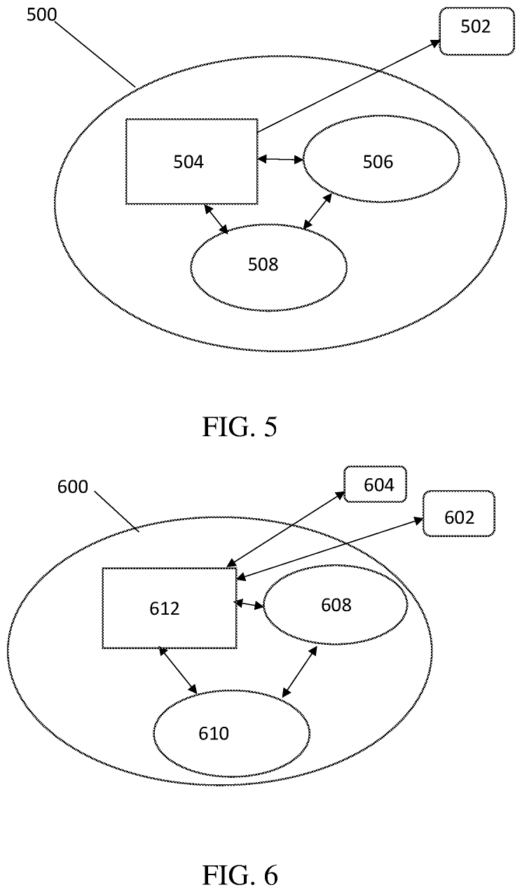

FIG. 5 is a diagram showing a system 500 having computer readable medium 504 comprising instructions which, when executed by a processor, initiates an AI agent 502 to be trained by the interaction of players 506, 508 during gameplay. In this example, the AI agent 502 does not use the trained data to affect the player interaction, only to train on the interaction of the players. In the next example of FIG. 6, the diagram shows a system 600 having computer readable medium 612 and multiple AI agents 602, 604 trained by the interaction of players 608, 610 and interaction with the AI agents wherein at least one of the AI agents may provide heatmaps to the computer readable medium 612.

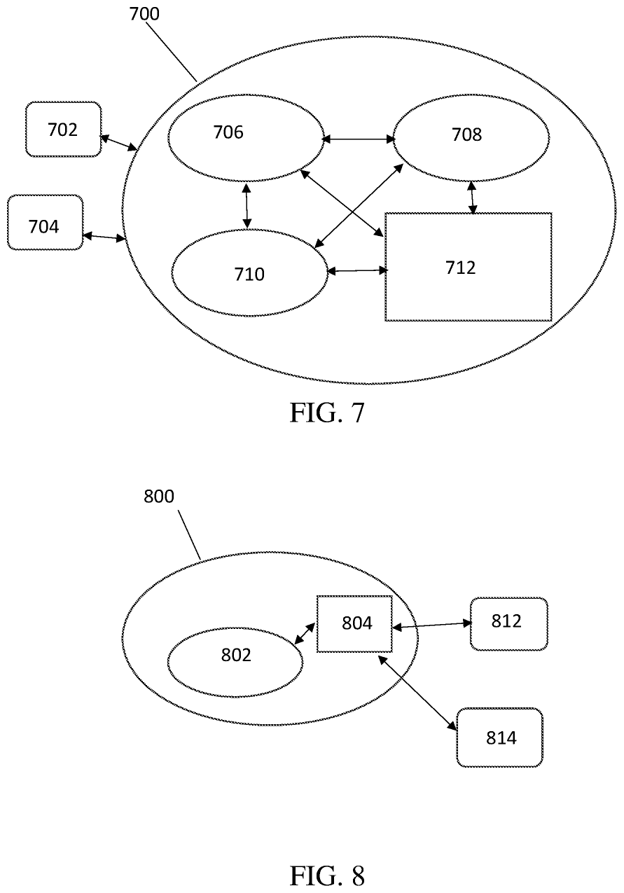

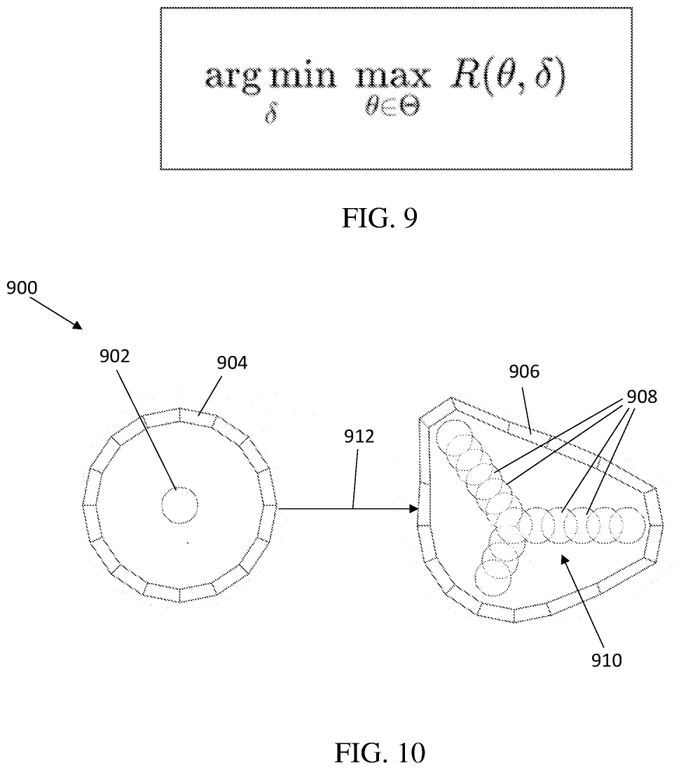

FIG. 7 is an alternate diagram of a system 700 having computer readable medium 712 and AI agents 702, 704 to be trained by the interaction of players 706, 708, 710 and interaction with the agent wherein the AI agents 702, 704 are trained by the system 700 as a whole.

FIG. 8 is a diagram showing a system 800 having computer readable medium 804 wherein multiple AI agents 812, 814 are trained using the computer interaction with a single player 802. The AI agent may be involved in the interaction wherein the computer system uses input data received from the AI agent.

FIG. 10 is a diagram illustrating an embodiment of a root sphere being perturbed and grown to allow for articulation and advancement underneath an elastic membrane in the virtual environment. Articulated structures are complex systems that consist of multiple interconnected parts or segments. These structures are often used in various fields such as robotics, architecture, and biomechanics. In this case, the articulated structures are applied to the architecture of a game which includes the game evolving using training of a neural network. The interconnected parts or segments, often referred to as nodes or spheres, are typically arranged in a specific pattern or configuration to achieve a desired functionality or characteristic. These structures are often designed to mimic or replicate the flexibility and adaptability of biological systems. For instance, the human body is an example of an articulated structure with bones acting as the nodes and joints serving as the connections. This allows for a wide range of motion and flexibility.

Computational networks are used for the distribution of communication signals and those within the articulated structure can enhance the functionality and performance of the structure.

Soft body simulation focuses on the visual representation of soft or deformable objects. The simulation of soft bodies involves complex mathematical models and algorithms to accurately depict the behavior and characteristics of these objects.

In the context of articulated structures, perturbed refers to the action of altering or causing a change in the state, position, or condition of a sphere in the articulated structure and is a result of the computational network operations.

FIG. 10 is a diagram showing a root element, being root sphere 902. Root sphere 902 is encapsulated by skin mesh 904. Root sphere 902 is perturbed and ‘grown’ 912 to allow for articulation 908 and advancement underneath an elastic membrane 906, a sort of digital ‘skin’. By this method a skeleton like structure capable of articulation is evolved underneath a skin from the base element and allows for articulation and movement of an object within virtual environment 900.

As shown in FIG. 10, one aspect of the present invention is directed to a system for growing an articulated structure 910. The system 900 includes a plurality of spheres 908, each sphere 908 disposed adjacent to at least one other sphere to form the articulated structure. The system includes an outer skin 906 to which the articulated structure 910 is attached, the outer skin 910 simulated as a soft body. The outer skin 906 has a geometric shape which may be a tetrahedron or a hexahedron. The system 900 includes a computational network integrated within connections between adjacent spheres for distributing communication signals. The system 900 includes a multiphase flow fluid simulation system in which the articulated structure 910 and outer skin 906 are embedded, the multiphase flow fluid simulation system including suspended particles. The outer skin may be configured to subdivide in response to tension caused by growth of the articulated structure whereby generation of sampleable parameters are influenced by gradient changes on the surface of the outer skin. The fluid simulation system is selected from the group consisting of Material Point Method (MPM), Smoothed Particle Hydrodynamics (SPH), Lattice Boltzmann Method, and Fluid-Implicit Particle (FLIP) method, and the interactions within this system contribute to the development of the skin surface parameters.

Another aspect of the present invention is directed to a computer readable medium including instructions which, when executed by a processor, cause the computer to carry out the steps of using a neural network to provide a heatmap to an avatar during gameplay wherein areas of interaction of the avatar are analyzed and applied to the heatmap to identify an interaction pattern of the avatar. The areas of the heatmap that have a lower value of interaction are assigned a lower priority area and the areas of the heatmap having a greater value of are assigned a higher priority. The steps include using the heatmap to allocate a greater portion of processor resources to the areas of the heatmap having a greater priority. The neural network may be a recurrent neural network. The neural network may be a large language model neural network for creating initial content and for enhancing simulation results.

Another aspect of the present invention is directed to a computer readable medium comprising instructions which, when executed by a processor, cause the computer to carry out the steps of initiating training on a neural network in providing a heatmap and updating information in the heatmap of input parameters used to identify priority language parameters. The areas of the heatmap that have a lower value parameter are assigned a lower priority and the areas of the heatmap having a greater value parameter are assigned a higher priority. The steps include using the heatmap to allocate a greater portion of processor resources to the areas of the heatmap having a greater priority, and using the information to determine appropriate type of model sizes and efficiencies to handle tasks according to priority. The neural network may be a recurrent neural network. The neural network may be a transformer model used in a Large Language Model.

Another aspect of the present invention is directed to a computer readable medium comprising instructions which, when executed by a processor, cause the computer to carry out the steps of providing a heatmap to an avatar during gameplay, using a generation system, identifying an area of interaction with other avatars or game environment and the objects within said the game environment. The steps include the generation system performing an analysis of a position of the heatmap using machine learning on the heatmap to identify an interaction pattern of the avatar and in response to the analysis inferring the areas of interaction within the game, the generation system dividing the areas based on interaction, wherein, the areas of the heatmap having a lower value of interaction as being a lower priority area and the areas of the heatmap having a greater value of interaction as being a higher priority area.

Another aspect of the present invention is directed to a computer-implemented method for training a neural network within a gameplay. The method includes providing player input data from the gameplay and the neural network establishing a baseline using the player user input data is a mechanism from the gameplay. The method includes the neural network performing a simulation on the baseline to generate loss function optimization based on differences between the simulation and baseline. The method includes updating a network parameter to reinforce the network and in response to updating the network parameter, generating, using the generation system, new content for the gameplay. Updating the network parameter may use feed-forward propagation, backpropagation or a combination of feed-forward propagation and backpropagation.

Another aspect of the present invention is directed to a computer readable medium including instructions which, when executed by a processor, cause the computer to carry out the steps of using a neural network to generate an object based on learned data wherein the neural network provides an overarching constraint for the system to evolve an object based on the training data received.

Another aspect of the present invention is directed to a method for growing an articulated structure having a plurality of connected spheres. The method includes connecting spheres in the articulated structure wherein each sphere is connected to a at least one other sphere and the articulated structure is attached at points to an outer skin. The outer skin is simulated as a soft body and comprises a geometric mesh shape selected from the group consisting of a tetrahedron and a hexahedron. The connections between the spheres form a network capable of distributing communication signals for computational processes that influence the movement and growth of the articulated structure. The growth of the articulated structure may cause stretching and deformation of the outer skin wherein the outer skin subdivides in areas of high tension and the subdivision of the outer skin results in a cascade of sampleable parameters across the skin surface, the parameters being influenced by gradient changes akin to a reaction-diffusion pattern. The method may include embedding the articulated structure and outer skin within a multiphase flow fluid simulation system, wherein the fluid simulation system is selected from the group consisting of Material Point Method (MPM), Smoothed Particle Hydrodynamics (SPH), Lattice Boltzmann Method, and Fluid-Implicit Particle (FLIP) method. The fluid simulation system may include suspended particles. Interactions between the suspended particles and the outer skin may contribute to the development of the skin surface parameters. The interactions between the suspended particles and the outer skin in the fluid simulation system may enhance the complexity and variability of the parameters on the skin surface.

Another aspect of the present invention is directed to a system for growing an articulated structure. The system includes a plurality of spheres, each sphere disposed adjacent to at least one other sphere of the plurality of spheres to form the articulated structure. The system includes an outer skin to which the articulated structure is attached, the outer skin simulated as a soft body, the outer skin having a geometric shape selected from the group consisting of a tetrahedron and a hexahedron. The system includes a computational network integrated within connections between adjacent spheres for distributing communication signals. The system includes a multiphase flow fluid simulation system in which the articulated structure and outer skin are embedded, the multiphase flow fluid simulation system including suspended particles. The outer skin may be configured to subdivide in response to tension caused by growth of the articulated structure whereby generation of sampleable parameters are influenced by gradient changes on the surface of the outer skin. The fluid simulation system may be selected from the group consisting of Material Point Method (MPM), Smoothed Particle Hydrodynamics (SPH), Lattice Boltzmann Method, and Fluid-Implicit Particle (FLIP) method, and the interactions within this system contribute to the development of the skin surface parameters.

Where a statistical model is used as a replacement model to be more efficient may include the use of a transformer model, such as an LLM. In one embodiment, statistical models such as those used by LLM's (Large Language Models) can be simplified and enhanced by the implementation of heatmaps to set priority in processor allotment. Some examples are text generation to generate coherent, human-like text, question answering, summarization, data augmentation, and the like.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer readable medium comprising instructions which, when executed by a processor, cause the computer to carry out the steps of:
using a neural network to provide a heatmap to an avatar during gameplay wherein areas of interaction of the avatar are analyzed and applied to the heatmap to identify an interaction pattern of the avatar;
wherein, the areas of the heatmap having a lower value of interaction are assigned a lower priority area and the areas of the heatmap having a greater value of are assigned a higher priority; and
using the heatmap to allocate a greater portion of processor resources to the areas of the heatmap having a greater priority.

2. The computer readable medium of claim 1 wherein the neural network is a recurrent neural network.

3. The computer readable medium of claim 1 wherein the neural network is a large language model neural network for creating initial content and for enhancing simulation results.

4. A computer readable medium comprising instructions which, when executed by a processor, cause the computer to carry out the steps of:
initiating training on a neural network in providing a heatmap and updating information in the heatmap of input parameters used to identify priority language parameters;
wherein, the areas of the heatmap having a lower value parameter are assigned a lower priority and the areas of the heatmap having a greater value parameter are assigned a higher priority; and
using the heatmap to allocate a greater portion of processor resources to the areas of the heatmap having a greater priority, and using the information to determine appropriate type of model sizes and efficiencies to handle tasks according to priority.

5. The computer readable medium of claim 4 wherein the neural network is a recurrent neural network.

6. The computer readable medium of claim 4 wherein the neural network is a transformer model used in a Large Language Model.

7. A computer-implemented method for training a neural network within a gameplay, the method comprising:
providing player input data from the gameplay,
the neural network establishing a baseline using the player user input data is a mechanism from the gameplay;
the neural network performing a simulation on the baseline to generate loss function optimization based on differences between the simulation and baseline;
updating a network parameter to reinforce the network; and
in response to updating the network parameter, generating, using the generation system, new content for the gameplay.

8. The computer-implemented method of claim 7 wherein updating the network parameter uses feed-forward propagation.

9. The computer-implemented method of claim 7 wherein updating the network parameter uses backpropagation.

10. The computer-implemented method of claim 7 wherein updating the network parameter uses feed-forward and backpropagation.
